(19) United States
(12) Patent Application Publication
(10) Pub. No.: US 2005/0047394 A1
(43) Pub. Date: Mar. 3, 2005

(54) Automatic contact navigation system

(76) Inventors: Jeff Hodson, Wheaton, IL (US); Roger Sumner, Batavia, IL (US); Mark Power, Carol Stream, IL (US); Carlo Bonifazi, Woodridge, IL (US); Craig Shambaugh, Wheaton, IL (US); Mark Michelson, Elburn, IL (US); Robert Beckstrom, Bolingbrook, IL (US); Anthony Dezonno, Bloomingdale, IL (US)

Correspondence Address: WELSH & KATZ, LTD, 120 S RIVERSIDE PLAZA, 22ND FLOOR, CHICAGO, IL, 60606, US

(21) Appl. No.: 10/651,329

(22) Filed: Aug. 28, 2003

(51) Int. Cl. H04L 12/28

(52) U.S. Cl. 370/352

(57) ABSTRACT

A method and apparatus are provided for guiding a conversation taking place between a client and an agent through a communication system. The method includes the steps of detecting an information content of the conversation, determining a goal of the client from the detected information content and suggesting a conversation topic to the agent to guide the conversation towards the goal of the client.

### FIELD OF THE INVENTION

The field of the invention relates to communication systems and more particularly to automatic call distributors.

### BACKGROUND OF THE INVENTION

Call-centers are generally known. A call-center is typically used wherever a large number of calls must be handled for some common enterprise. Typically, the calls of the enterprise are routed through the call-center as a means of processing the calls under a common format.

Call-centers typically include at least three elements: an automatic call distributor (ACD), a group of agents for handling the calls, and a host computer containing customer information. The individual agents of the groups of agents are each typically provided with a telephone console and a computer terminal. The telephone terminal receives customer calls distributed to the agent by the ACD. The terminal may be used to retrieve customer records from the host.

Call-centers are typically automated in the delivery of calls to agents and in the retrieval of customer records for use by agents. Features within the PSTN such as dialed number identification service (DNIS) and automatic number identification (ANI) may be used to determine not only the destination of the call, but also the identity of the caller. DNIS and ANI information, in fact, may be delivered by the PSTN to the ACD in advance of call delivery.

Based upon the destination of the call and identity of the caller, the ACD may select the agent most qualified to service the call. By sending an identifier of the selected agent along with the identity of the caller to the host, the host may automatically retrieve and download customer records to the agent's terminal at the same instant as the call arrives.

While call-centers are effective, the skill level of agents varies considerably. To simplify and add consistency to call handling, agents are often provided with written scripts to follow during conversations with customers. While such scripts help, they may prove ineffective in the case of a customer who asks questions or otherwise does not allow the agent to follow the prepared script. Accordingly, a need exists for a way of making presentations that is not limited to a predetermined format.

### SUMMARY

A method and apparatus are provided for guiding a conversation taking place between a client and an agent through a communication system. The method includes the steps of detecting an information content of the conversation, determining a goal of the client from the detected information content and suggesting a conversation topic to the agent to guide the conversation towards the goal of the client.

### BRIEF DESCRIPTION OF THE DRAWINGS

FIG. 1 depicts a system for guiding a conversation in accordance with an illustrated embodiment of the invention;

FIG. 2 depicts a system within which the system of FIG. 1 may be used; and

FIG. 3 depicts a set of contact files that may be used by the system of FIG. 1.

### DETAILED DESCRIPTION OF AN ILLUSTRATED EMBODIMENT

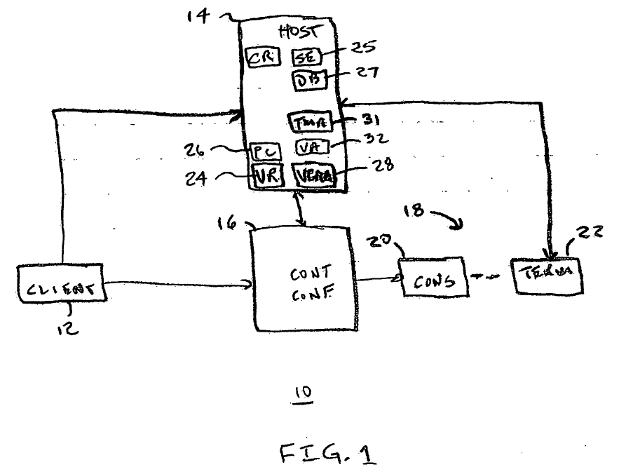

FIG. 1 is a block diagram of a system 10, shown generally, that provides conversation guidance to an agent during a conversation with a client. The system 10 supports conversations between the client and agent through any of a number of different communication systems and mediums.

For example, where the client is using a telephone 12, the conversation may occur through the telephone 12 of the client and a console 20 of an agent working at an agent workstation 18. Alternatively, where the client is using a computer 12, the conversation may occur as a chat session, e-mail exchange or as a voice session under a Voice-over-IP (VoIP) format between the computer 12 of the client and terminal 22 of the agent through the host 14.

In general, FIG. 1 depicts a client communication device 12 (e.g., a POTS telephone, cellular telephone, computer, etc.) that may be connected to a contact conferencing (CONT CONF) device 16 or to the host 14 and through which the client may converse with the agent working at an agent station 18. As shown, the agent station 18 may include a telephone console 20 and a computer terminal 22.

Communication between the client 12 and agent 18 may occur under any one of the number of different formats discussed above. In each case, a host 14 may monitor the conversation and suggest conversation topics and responses for the benefit of the agent 18.

For example, the CONT CONF device 16 may function to form a three-party connection among the client 12, agent 20 and a pair of voice recognition (VR) applications 24. One VR 24 may be provided on an inbound path to recognize words spoken by the client 12. A second VR 24 may be provided on an outbound path to recognize words spoken by the agent 20.

A similar packet conferencing (PC) application 26 may operate within the host 14 in the case of VoIP calls between the client 12 and agent terminal 22 through the host 14. In the case of a VoIP call, the PC 26 may function to route voice information of the client 12 and agent terminal 22 to the appropriate VR 24.

A content analysis application (CAA) 28 within the host 14 may function to analyze the exchange between the client 12 and agent 18, determine a goal of the client 12 and prompt the agent 18 with a subject matter intended to guide the conversation towards the client goal. As used herein, the step of suggesting a subject matter to guide a conversation towards the client goal means providing suggestions perceived only by the agent that are directed towards achieving the client's conversational goal and that are directed to adapting the conversational content of the agent's input to the conversational tendencies and emotional state of the client.

It should be noted in this regard that the client's conversational goal may not be objectively constant, but may change based upon agent input. Accordingly, the goal perceived by the CAA 28 may change during the conversation along a set of previously recognized paths.

The conversational tendencies of the client may be those measured during a current conversation or those measured during previous conversations and stored as a call record of the client 12 in the host 14. Any previously measured conversations may have been between the client and the same or a different agent.

It is generally understood that an agent who adapts his conversational tendencies to that of the client tends to be more successful than an agent who does not. Further, some conversational tendencies (e.g., word inflection) tend to be subtle and may not be detected by all agents.

In the case of the system 10, any detectable conversational tendency may be used as a basis for guiding the conversation. For example, some clients tend to seek to achieve a certain comfort level with the agent as a preliminary goal of the conversation before moving on to an objective of a conversation as a secondary goal. The chit-chat used to establish the desired comfort level may be viewed as a form of trust-building between the client and agent. If the agent rushes the client, the client may not feel that he trusts the agent and the conversation may never arrive at the objective of the client or at a suitable outcome for the agent.

In the case of the system 10, irrelevant comments (i.e., chit-chat) may be recognized by key word detection. Since chit-chat tends to involve generally repeatable subject matter (e.g., sports, weather, family, etc.), the CAA 28 may recognize clients using particular forms of chit-chat and prompt the agent 18 to conform to the client tendencies in this regard.

Alternatively, other clients may tend to be impatient and immediately proceed to the object of the call or to a initiate a review of the content of past calls. In this situation, if the agent should attempt to engage chit-chat, then the client may become irritated.

The CAA 28 may also recognize impatient clients 12 using this conversational paradigm. The system 10 may prompt the agent dealing with this type of client 12 accordingly.

The emotional state of a client 12 may be the state measured during a current conversation. However, the adaptation of the conversational content of the agent may also be modified by other emotional factors (e.g., excitability, irritability, etc.) detected in previous contacts with the client.

The emotional state of the client 12 may be measured by any of a number of factors. A voice analyzer 32 may function to measure a voice pitch or word rate of the client 12. Any short-term deviations outside a threshold range may be identified as signs of emotional distress or anger.

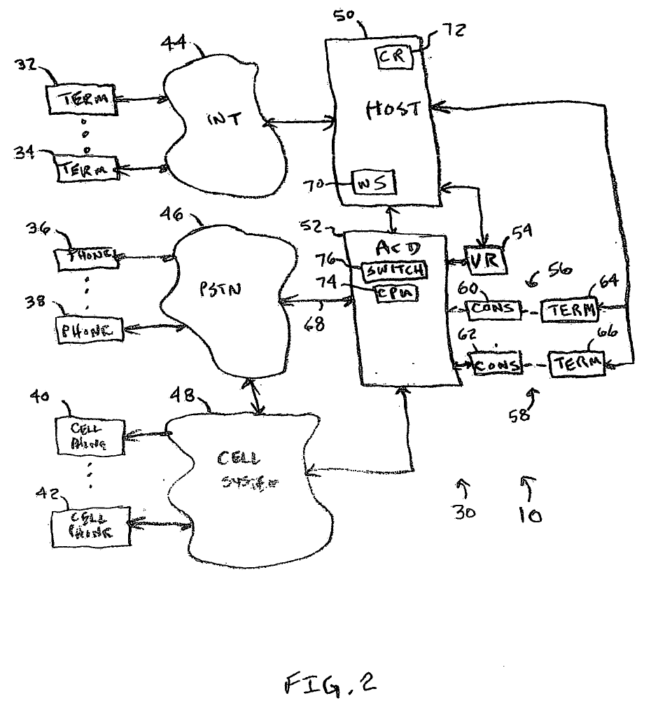

In one illustrated embodiment of the invention, the system 10 may be used within a contact processing system 30, as shown in FIG. 2. The contact processing system 30 may be used by an organization (e.g., an environmental organization, a political organization, a merchant, etc.) to setup contacts through information exchange paths between external clients of the organization (e.g., a client using an communication device 32, 34, 36, 38, 40, 42) and agents of the organization (e.g., a selected agent working at an agent station 56, 58) for purposes of advancing the agenda of the organization.

As used herein, a contact is the exchange of information between humans (i.e., a human client and a human agent) through a communication system (e.g., 44, 46, 48, etc.). A contact may refer to a voice conversation based upon a telephone call using a conventional, switched circuit telephone connection provided through the public switched telephone network (PSTN) 46 or cellular system 48. A contact may also be a Voice-over-Internet-Protocol (VoIP) voice call, a chat session, or an e-mail exchange established through the Internet 44.

For example, where the organization is a merchant, the contact processing system 30 may be structured around a telephone connection (e.g., a set of incoming trunk lines) 68 with the PSTN 46. The merchant may advertise its wares through television or newspaper ads. The ads may provide one or more telephone numbers associated with the telephone connection 68 of automatic call distributor (ACD) 52 of the contact center 30. If the organization has many organizational divisions (e.g., a department store), then a separate telephone number may be provided for each department.

In order to service telephone calls, the contact processing system 30 may have a number of agent stations 56, 58. Each agent station 56, 58 may be provided with a telephone console 60, 62 and a computer terminal 64, 66.

The contact processing system 30 may also function to place outgoing calls to clients. In support of outgoing calls, the contact processing system 30 may maintain a list of telephone numbers of clients 36, 38 within a set of client records 72. A host 50 may retrieve telephone numbers from the client records 72, as needed, and transfer the numbers to the automatic call distributor (ACD) 52.

The host 50 may transfer the numbers to a central processing unit (CPU) 74 within the ACD 52. The CPU 74 may monitor the activity of the agents 56, 58 and place calls to clients 36, 38 through the PSTN 46 in anticipation of agents 56, 58 becoming available.

As the CPU 74 places or receives calls, it assigns a call identifier to the call and opens a contact record for the call. If the call is an outgoing call, then the contact record would include at least the telephone number of the called party and, possibly, an identifier of the call campaign triggering the call. If the call is an incoming call, then the contact record may include call associated information. Call associated information may include ANI or DNIS information delivered from the PSTN 46 to the ACD 52 along with the call.

In the case of outgoing or incoming calls, the CPU 74 may send a contact arrival message containing the information of the contact record to the host 50. In the case of outgoing calls, the contact arrival message may be send when the called party answers and the CPU 74 determines that the call has not been answered by an answering machine. In the case of incoming calls, the contact arrival message may be sent upon detection of the call on an inbound trunk line.

Upon receiving the contact arrival message, the host 50 may retrieve customer records from a customer database 72. On outgoing calls, the telephone number of the called party may be used as an identifier of customer files. On incoming calls, ANI information may be used as the identifier.

Upon retrieving any customer records, an agent 56, 58 may be selected for handling the call. Agent selection may be accomplished by an agent selection application (not shown) operating within the host 50 or CPU 74. Agent selection may be based upon any criteria (e.g., agent skill, past customer purchases, customer preferences, objectives of an outgoing call campaign, etc.).

Once an agent is selected, the CPU 74 may instruct the switch 76 to couple the call to the telephone console 60, 62 of the selected agent 56, 58. The CPU 74 may also send a “contact routed” message to the host 50 including the call identifier and selected agent 56, 58. In response, the host 50 may deliver customer records to the terminal 64, 66 of the selected agent 56, 58 as a screen pop coincident with call delivery to the agent.

As an alternative to calls placed or received through the PSTN 46, the contact center 30 may also establish contacts through the Internet 44. A web site 70 may be provided to promulgate the objectives of the organization. Outgoing contact campaigns may be initiated by retrieving e-mail addresses of existing clients and forwarding e-mail messages containing information consistent with the objectives of the organization.

In the case of the website 70, clients may access the website 70 using a terminal 32, 34 and download one or more webpages of organizational information. If the organization is a merchant, then the webpages may provide information on one more product lines.

As clients 32, 34 access the website 70, one or more webpages may be downloaded to the client 32, 34. As the client 32, 34 browses the website 70, the host 50 may open a contact record including at least the URL of the client 32, 34 and any web pages visited.

Contained within the webpages may be one or more interactive windows or softkeys that allow information requests or direct contact with an agent 56, 58. In the case of interactive windows, the client 32, 34 may enter a particular question and his e-mail or telephone number and activate a “SUBMIT” button. Alternatively, the client 32, 34 may simply active a “TALK WITH AGENT” softkey.

In either case, the host 50 may process the activity as a contact request and process the activity accordingly. Any information entered into an interactive window may be added to the contact record.

To process the contact request, the host 50 may retrieve the contact record and determine a subject matter of the request based upon any webpages visited or questions entered through an interactive window. The host 50 may then retrieve a set of agent skills and search for and select an agent 56, 58 having the required skills. Finally, the host 50 may send the contact record to the selected agent 56, 58. In the case of a “TALK WITH AGENT” request, the host 50 may also send instructions activating an VoIP application within the agent's terminal 64, 66 and establishing VoIP contact with the requesting client 32, 34.

Once a contact established through the Internet 44, PSTN 46 or cellular system 48 is assigned to an agent 56, 58, the simplified diagram of FIG. 1 may be used to describe the process of prompting the agent.

The prompting of the agent 18 may occur on any of a number of levels depending upon the circumstances. One circumstance where the system 10 may have great value is where the caller cannot be identified from call associated information (e.g., ANI). This situation may occur for any of a number of reasons (e.g., the client has never called before, has a new telephone number, calls from an unfamiliar telephone, etc.). In this situation, the agent 18 would be required to obtain a name or account number from the contact and then to familiarize himself/herself with the account while at the same time conversing with the client 12.

In order to expedite the goals of the contact 12, the system 10 may monitor the contact 12 for indicia of identity. While any method of identifying the contact 12 may be used, the preferred method of identification may be by account number. The agent may ask for and the contact 12 may provide an account number. In conjunction therewith or followed closely thereafter, the agent 18 may activate a softkey on a screen of his terminal 22 confirming that the alpha-numeric sequence recognized by the VR application 24 and transferred to the CAA 28 is the account number.

Alternatively, the capture of the account number may happen automatically by monitoring the voice connections (or information exchanges in the case of a chat session or e-mail exchange). If the VR application 24 detects the words “account number” spoken (or transmitted) by the agent 18 or contact 12 followed by the recitation (or transmission) of a number by the contact 12, then the CAA 28 may assume that the recited (transmitted) number is the account number of the contact 12, and proceed accordingly.

In either case, the CAA 28 may search the customer record database to identify a set of records of the contact 12. If the account number corresponds to an existing account, then the CAA 28 may retrieve the account records along with a set of conversational traits of the contact 12.

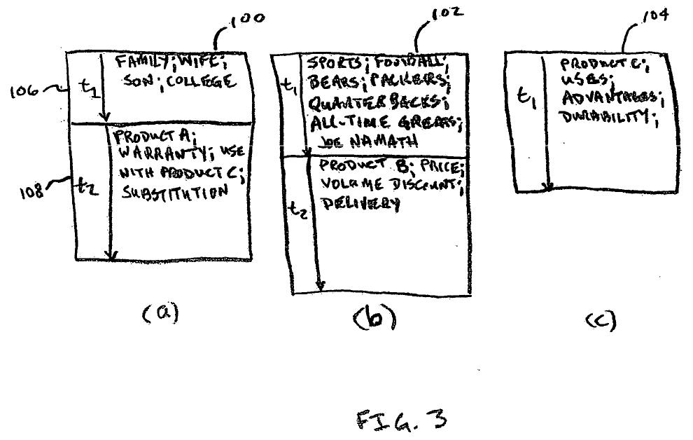

FIG. 3 depicts contact files 100, 102, 104 for three different contacts 12. As shown, at least some of the files may be divided into a greeting period and a business period. As has been recognized, at least some contacts 12 prefer to engage in chit-chat and to, otherwise, “warm up” to the, heretofore, “unknown” agent 18 before they are willing to “get down to business”. The CAA 28 may use this information to pace the call to conform with the preferences of the contact 12.

However, even where the CAA 28 uses conversational traits derived from past conversations with the contact, the content and course of a present conversation may always take precedence over prior tendencies. For example, if the contact is in a hurry or otherwise preoccupied, the CAA 28 may detect such change in pace based upon the operation of the voice analyzer 32 and adjust its suggestions to the agent 18 in such a manner as to expedite a conclusion to the conversation.

In the case of the call records 100, 102, the greeting period may include key words recognized during previous conversations with the contact 12 and stored within the call record 100, 102. A time period t₁ may represent an average length of the greeting period of prior conversations.

It should be noted that at least some contacts 12 may engage in a very short or no greeting period and instead prefer to “get down to business” immediately. A contact 12 of this type may have a call record similar to that depicted in FIG. 3c.

In general, the CAA 28 may divide a conversation into two or more classifications. A first portion may be a greeting portion and a second portion may be an object of the call portion. While in the greeting portion, the CAA 28 may continue to prompt the agent 18 with suggested topics in support of the greeting until either of two things happen. First, if a predetermined period of time passes, then the CAA 28 may make suggestions prompting the agent 18 to inquire of the contact 12 as to the purpose of the call. Alternatively, if the CAA 28 detects key words from the contact 12 that are not consistent with the greeting portion, but are consistent with a possible objective of the call, then the CAA 28 may begin prompting the agent 18 with information directed towards that possible call object.

In the case of the contact associated with the first contact record 100, the agent 18 may be prompted at the beginning of the conversation with key words from the greeting portion 106 of prior conversations. In the case of a contact 12 with the associated record 100, the agent 18 may be prompted with the key words (e.g., “ask about the family”).

As the agent 18 asks about the family, the CAA 28 continues to monitor the conversation. As the CAA 28 monitors the conversation, it continues to perform key word detection and classification. Classification is performed to group words according to subject matter and to detect break points in the conversation suggesting other objectives of the call.

Blind calls (i.e., from new customers) may be handled in a similar manner. If the caller inquires as to the well-being of the agent 18, the CAA 28 may suggest a related comment of the contact 12. If the caller inquires as to the weather, the CAA 28 suggests a related comment, but may add a query as to where the caller is calling from to improve the relevance of later suggestions.

As the conversation continues, the CAA 28 times the greeting portion. If the greeting portion exceeds an average time t₁ of the greeting portion of prior conversations (or in this case an average of all conversations from contacts), then the CAA 28 may suggest that the agent 18 ask the purpose of the call.

Alternatively, if the CAA 28 should detect key words from the contact 12 that is inconsistent with the greeting classification, then the CAA 28 may perform a database search to identify another classifications. To this end the CAA 28 may transfer the inconsistent key words to a search engine 25. The search engine 25 may search a database 27 for classes of information similar to the inconsistent key word.

For example, if the agent 18 is an employee of a merchant, then the search engine 25 may attempt to identify products of the merchant related by the inconsistent key word. Where a match is found, the CAA 28 may prompt the agent 18 with information about the product.

In general, if classes of information related to the key word are found, then descriptors of those classes may be transferred to the CAA 28. Within the CAA 28, a comparison may be made between the descriptors and the inconsistent key words. Descriptors with close matches with the inconsistent keywords may also be compared with other key words of prior conversation found within the object of the call portion 108 of the contact file 100 to further improve the reliability of the prompting.

Once a matching classification is found, the CAA 28 may begin prompting the agent 18 through a prompter with information from the identified class. Prompting may be accomplished under any of a number of different formats. For example, suggested subject matter may be transferred and displayed within a prompter that includes a prompting window on a display of the terminal 22 or the agent 18. Alternatively, the prompter may include a speech synthesizer that converts the subject matter into an audio message that, in turn, may be played through an earphone of the agent 18 and only heard by the agent 18.

If during a conversation with a contact, the voice analyzer 32 and CAA 28 should detect a change in emotional state, then the CAA 28 may attempt to differentiate between excitement or anger. The detection of the change in emotional state may be detected within the voice analyzer 32 based upon a change in word rate, voice pitch or volume, based upon threshold values.

The detection of anger may be used to initiate suggestions directed to terminating the contact. The detection of excitement may be used as an indication that the contact is a good candidate for up-selling in the commercial context and to initiate up-selling suggestions.

Once a change in emotional state is detected, key word detection and grouping may be used to determine which is which. For example, excitement would normally not be expected to significantly affect change word usage, but anger would. In this case, a special anger word grouping may be created and matched using the search engine 25.

Further, the detection of irritation may also be used to modify the prompting provided by the CAA 28. However, irritation may be more difficult to detect because of differences among contacts. However, a combination of voice analysis and word usage may be used as a good indicator of the emotional state of the contact. Further, threshold levels may be adjusted based upon past experience with the contact. Alternatively, a softkey may be provided on the agent's terminal 22 that allows the agent 18 to signal the CAA 28 when the agent 18 detects that the conversation is not progressing in a positive manner.

In response to the detection of irritation, the CAA 28 may function to re-analyze recent exchanges (e.g., within the last 30 seconds) between the agent 18 and contact 12 to identify ambiguities and other optional paths (i.e., goals) that could have been followed. In this case, where ambiguities or other goal are identified, the CAA 28 may make suggestions directed to clarifying any identified ambiguities and/or choice of goals.

In the case where the CAA 28 identifies an ambiguity or alternate choice of goal, the CAA 28 may make suggestions to the agent 18 regarding other choices associated with the ambiguity or choice of goal. If the CAA 28 detects an affirmative response from the contact regarding one of the choices, then the CAA 28 may re-direct its suggestions along that path. If the CAA 28 detects a negative response, then the CAA 28 may suggest other options or terminate the contact.

A specific embodiment of a method and apparatus for guiding a conversation has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of guiding a conversation taking place between a client and an agent through a communication system, such method comprising:
detecting an information content of the conversation;
determining a goal of the client from the detected information content; and
suggesting a subject matter to the agent to guide the conversation towards the goal of the client.

2. The method of guiding a conversation as in claim 1 further comprising determining an identity of the client from the detected information content.

3. The method of guiding a conversation as in claim 2 further comprising retrieving contact information based upon the determined identity of the client.

4. The method of guiding a conversation as in claim 3 further comprising defining the retrieved information as personal information about the client.

5. The method of guiding a conversation as in claim 1 wherein the step of detecting the information content further comprises recognizing a voice content of a conversation between the client and the agent.

6. The method of guiding a conversation as in claim 1 wherein the step of detecting an information content of the conversation further comprises performing stress analysis on a voice of the client.

7. The method of guiding a conversation as in claim 6 wherein the step of performing stress analysis further comprises measuring a voice pitch of the voice of the client.

8. The method of guiding a conversation as in claim 6 wherein the step of performing stress analysis further comprises measuring a word rate of the voice of the client.

9. The method of guiding a conversation as in claim 1 wherein the step of suggesting a conversation topic further comprises displaying a text message on a terminal used by the agent.

10. The method of guiding a conversation as in claim 1 wherein the step of suggesting a conversation topic further comprises providing an audible message through an earphone of the agent heard only by the agent.

11. An apparatus for guiding a conversation taking place between a client and an agent through a communication system, such apparatus comprising:
means for detecting an information content of the conversation;
means for determining a goal of the client from the detected information content; and
means for suggesting a subject matter to the agent to guide the conversation towards the goal of the client.

12. The apparatus for guiding a conversation as in claim 11 further comprising means for determining an identity of the client from the detected information content.

13. The apparatus for guiding a conversation as in claim 12 further comprising means for retrieving contact information based upon the determined identity of the client.

14. The apparatus for guiding a conversation as in claim 13 further comprising means for defining the retrieved information as personal information about the client.

15. The apparatus for guiding a conversation as in claim 11 wherein the means for detecting the information content further comprises means for recognizing a voice content of a conversation between the client and the agent.

16. The apparatus for guiding a conversation as in claim 11 wherein the means for detecting an information content of the conversation further comprises means for performing stress analysis on a voice of the client.

17. The apparatus for guiding a conversation as in claim 16 wherein the means for performing stress analysis further comprises means for measuring a voice pitch of the voice of the client.

18. The apparatus for guiding a conversation as in claim 16 wherein the means for performing stress analysis further comprises means for measuring a word rate of the voice of the client.

19. The apparatus for guiding a conversation as in claim 11 wherein the means for suggesting a conversation topic further comprises means for displaying a text message on a terminal used by the agent.

20. The apparatus for guiding a conversation as in claim 11 wherein the means for suggesting a conversation topic further comprises means for providing an audible message through an earphone of the agent heard only by the agent.

21. An apparatus for guiding a conversation taking place between a client and an agent through a communication system, such apparatus comprising:
a voice recognition application adapted to detect an information content of the conversation;
a content analysis application adapted to determine a goal of the client from the detected information content; and
a prompter adapted to suggest a subject matter to the agent to guide the conversation towards the goal of the client.

22. The apparatus for guiding a conversation as in claim 21 further comprising a database of customer records adapted to determining an identity of the client from the detected information content.

23. The apparatus for guiding a conversation as in claim 21 wherein the voice recognition application further comprises a voice analyzer adapted to perform stress analysis on a voice of the client.

24. The apparatus for guiding a conversation as in claim 21 wherein the prompter further comprises a terminal adapted to display a text message to the agent.

25. The apparatus for guiding a conversation as in claim 21 wherein the prompter further comprises an earphone adapted to provide an audible message heard only by the agent.
